(19) United States
(12) Patent Application Publication
(10) Pub. No.: US 2024/0048545 A1
(43) Pub. Date: Feb. 8, 2024

(54) AUTHENTICATION OF TRUSTED USERS

(71) Applicant: Microsoft Technology Licensing, LLC, Redmond, WA (US)

(72) Inventors: Jessie M. KAWATA, South Pasadena, CA (US); Adam KELLY, North Vancouver (CA); Anuradha PADTE, Seattle, WA (US); Nelson Michael ROZO, Seattle, WA (US); Hyunsun KIM, New York, NY (US); Cory Alexander FERRO, Overland Park, KS (US); Savyasachi C. NAFREY, North Vancouver (CA); Xiaohan LI, Bumaby, CA (US); Lionel COLING, North Vancouver (CA); Xuewei WANG, Vancouver (CA); Julian Harvery Morgan DICKS, Vancouver (CA); Kristofer CASTRO, Coquitlam, CA (US); Hannah WILKINSON, Ottawa (CA); William Christopher SLUSS, Forest Hill, MD (US); Sara A. SCHLAGEL, Seattle, WA (US); Gregory Henri Regis MIALON, Kirkland, WA (US); Wen QIU, Vancouver (CA); Casey Shea Dickson, Seattle, WA (US)

(21) Appl. No.: 18/344,497

(22) Filed: Jun. 29, 2023

Related U.S. Application Data
(60) Provisional application No. 63/396,209, filed on Aug. 8, 2022.

(51) Int. Cl. H04L 9/40; H04L 67/02

(52) U.S. Cl. CPC H04L 63/08; H04L 67/02; H04L 63/104

(57) ABSTRACT

According to examples, an apparatus includes a processor that is to cause an application to be provided through which information pertaining to a first user is to be displayed, receive authentication information of a second user, in which the authentication information includes an identifier of the second user and information that the second user uses for authentication to access a web-based application, determine whether the identifier of the second user is linked to an identifier of the first user, determine whether the authentication information authenticates the second user to access the web-based application, and based on a determination that the identifier of the second user is linked to the identifier of the first user and the authentication information authenticates the second user to access the web-based application, perm it the second user to access the information pertaining to the first user through the application.

### CROSS-REFERENCE TO RELATED APPLICATIONS

This application claims priority to U.S. Provisional Application No. 63/396,209, filed on Aug. 8, 2022. The entire contents of which is hereby incorporated by reference.

### BACKGROUND

Many educational institutions use on-line applications through which teachers and/or administrators of the educational institutions provide information regarding students of the educational institutions. The information often include courses in which the students are enrolled (or for which they have registered), coursework assigned to the students, the students' grades, messages to the students, etc. To ensure privacy, the students are typically authenticated prior to being granted access to their information through the on-line application. Particularly, the students are required to enter credentials through the on-line application and, if deemed to be valid, are granted access to their information. In many instances, parents and/or guardians also access information regarding the students. In these instances, the parents and/or guardians are also authenticated prior to being granted access to their students' information.

### BRIEF DESCRIPTION OF DRAWINGS

Features of the present disclosure are illustrated by way of example and not limited in the following figure(s), in which like numerals indicate like elements, in which:

FIG. 1 shows a block diagram of a network environment that includes an apparatus that causes an application to be provided through which a first user and a second user access information pertaining to the first user, in accordance with an embodiment of the present disclosure;

FIG. 2 depicts a block diagram of the apparatus depicted in FIG. 1, in accordance with an embodiment of the present disclosure;

FIGS. 3A-3G, respectively, depict windows that instruct a second user to log into an account or create a new account, in accordance with an embodiment of the present disclosure;

FIGS. 4A-4E, respectively, depict windows that provide a first user information through an application, in accordance with an embodiment of the present disclosure;

FIGS. 4F-4H, respectively, depict windows that display video conferencing and chatting communication techniques, in accordance with an embodiment of the present disclosure;

FIG. 4I shows a window in which a connection between a school official and a second user may be set up using a school data sync (SDS), in accordance with an embodiment of the present disclosure;

FIG. 5 depicts a flow diagram of a method for providing an application through which a first user and a second user access information pertaining to the first user, in accordance with an embodiment of the present disclosure; and

FIG. 6 shows a block diagram of a computer-readable medium that has stored thereon computer-readable instructions for providing an application through which a first user and a second user are to access information pertaining to the first user, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on. In the addition, the use of the terms “first,” “second,” “third,” etc., are not intended to denote a specific order of elements, but instead are intended to distinguish the elements with respect to each other.

Disclosed herein is a school connection application, which provides a web-application experience for parents and guardians of students. The school connection application enables parent and guardian engagement with their child's (or other charge's) education. By enabling secure via the school connection application, timely, and centralized views into assignments, grades, attendance, and other insights, parents and guardians can proactively support their individual child's needs. In addition, the school connection application disclosed herein empowers parents and guardians with contextual information to communicate and connect with educators and other supporting individuals in their child's institutional community.

Also disclosed herein is a guardian resource gateway, which provides techniques that permit applications for parents and guardians to securely access data about their children or other charges. By authenticating parents and guardians using trusted accounts (e.g., trusted accounts managed via a Microsoft account (MSA) identity provider in Azure Active Directory) and building an authorized trust relationship, the guardian resource gateway bridges the gap between a school cloud and a consumer cloud and permits the parents and guardians to perform activities on behalf of the students. Particularly, the present disclosure enables a second user (e.g., a guardian) to access information about a first user (e.g., a student) through an application when the second user is authenticated using authentication information of the second user. The authentication information is used to determine whether the second user is permitted to access a web-based application that differs from the school connection application. For instance, parents and guardians are able to use authentication information for existing accounts, such as an @outlook.com or an @hotmail.com account to gain access to the school connection application.

Through use of the authentication information for existing accounts, the second users, in many instances, do not need to create a new account to access the school connection application. As a result, application developers may not need to develop additional accounts for the second users, which reduces processing and energy resource utilization in the usage of the school connection application. Additionally, authentication processes used to verify the authentication information for an existing account of the second user may be relatively more secure than those used solely for the school connection application. The present disclosure may thus enable stronger protection against unwanted, illegitimate, or malicious access to the school connection application.

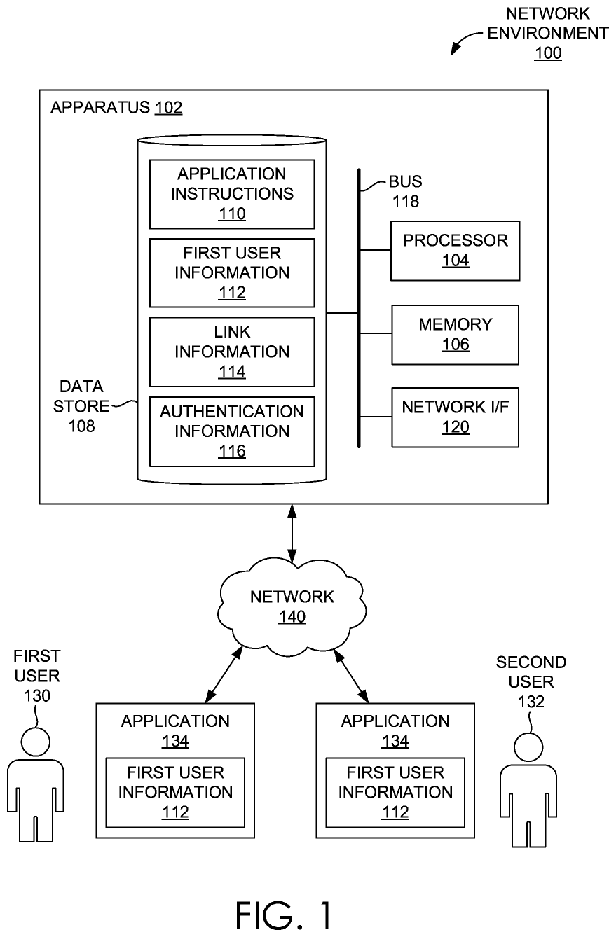

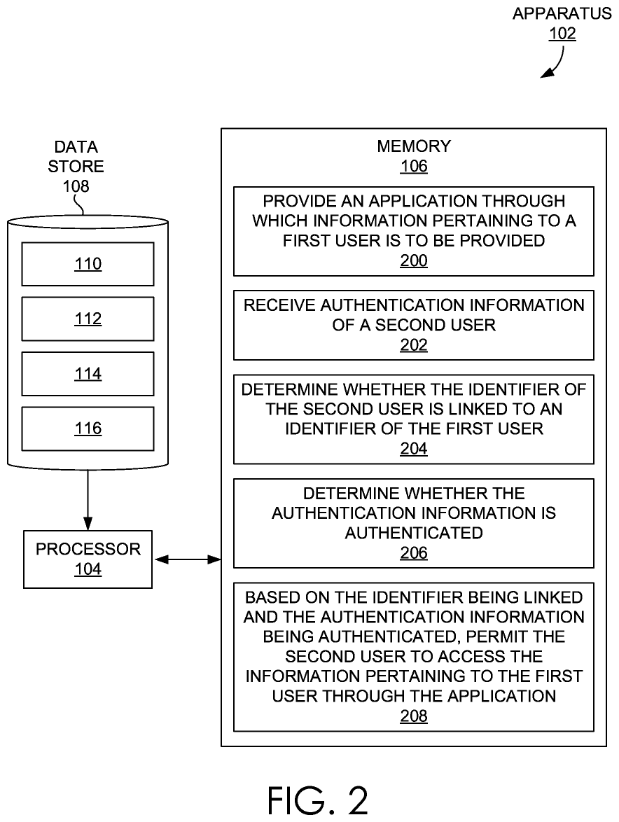

Reference is first made to FIGS. 1 and 2. FIG. 1 shows a block diagram of a network environment 100 that includes apparatus 102 having processor 104; memory 106; data store 108 having application instructions 110, first user information 112, link information 114, authentication information 116; bus 118; network OF 120; first user 130; second user 132; application 134 having first user information 112; application 134 having first user information 112; and network 140. The apparatus 102 causes application 134 to be provided through which first user 130 and second user 132 access information pertaining to the first user 130 (e.g., first user information 112) in accordance with an embodiment of the present disclosure. The apparatus 102 also permits the second user 132 to access the first user information 112 based on a determination that an identifier of the second user 132 is linked to an identifier of the first user 130 and that authentication information of the second user 132 is authenticated. FIG. 2 depicts a block diagram of the apparatus 102 depicted in FIG. 1, in accordance with an embodiment of the present disclosure. It should be understood that in some examples the network environment 100 and the apparatus 102 include additional features. In some examples, some of the features described herein are removed and/or modified without departing from the scopes of the network environment 100 and the apparatus 102.

The apparatus 102 may be a server of an online services provider, a provider of web-based applications, and/or the like. In some examples, the apparatus 102 is part of a cloud-based web services provider. In addition or in other examples, the functionalities of or operations that the apparatus 102 performs are distributed across multiple servers, multiple virtual machines, and/or the like, on the cloud. In some examples, the apparatus 102 performs authentication operations of users to determine whether the users are to be granted access to web-based applications. Thus, for instance, the apparatus 102 receives authentication information from users and enables the users to access web-based applications based on a determination that the authentication information is authenticated for the users. In other words, the apparatus 102 determines that a user is authenticated when the authentication information of the user matches known or previously stored authentication information of the user.

As shown in FIGS. 1 and 2, the apparatus 102 includes processor 104 that controls operations of the apparatus 102. The apparatus 102 is also depicted as including a memory 106 on which instructions that the processor 104 accesses and/or executes are stored. In addition, the apparatus 102 is depicted as including the data store 108 on which the processor 104 stores various information as discussed herein. The processor 104 is a semiconductor-based microprocessor, a central processing unit (CPU), an application specific integrated circuit (ASIC), a field-programmable gate array (FPGA), and/or other hardware device. The memory 106, which may also be termed a computer readable medium, is, for example, a Random Access memory (RAM), an Electrically Erasable Programmable Read-Only Memory (EEPROM), a storage device, or the like. The memory 106 is, in some examples, a non-transitory computer readable storage medium, where the term “non-transitory” does not encompass transitory propagating signals. In any regard, the memory 106 is depicted as having stored thereon machine-readable instructions that the processor 104 executes. The data store 108 is also be a Random Access memory (RAM), an Electrically Erasable Programmable Read-Only Memory (EEPROM), a storage device, or the like.

Although the apparatus 102 is depicted as having a single processor 104, it should be understood that the apparatus 102, in some examples, includes additional processors and/or cores without departing from a scope of the apparatus 102. In this regard, references to a single processor 104 as well as to a single memory 106 should be understood to additionally or alternatively pertain to multiple processors 104 and/or multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 may be distributed across multiple apparatuses 102 and/or multiple processors 104.

With particular reference to FIG. 2, the memory 106 is shown as having stored thereon machine-readable instructions 200-208 that the processor 104 is configured to execute. Although the instructions 200-208 are described herein as being stored on the memory 106 and thus include a set of machine-readable instructions, the apparatus 102 includes hardware logic blocks that perform functions similar to the instructions 200-208 in other examples. For instance, the processor 104 may include hardware components that execute the instructions 200-208. In other examples, the apparatus 102 may include a combination of instructions and hardware logic blocks to implement or execute functions corresponding to the instructions 200-208. In any of these examples, the processor 104 implements the hardware logic blocks and/or execute the instructions 200-208. As discussed herein, the apparatus 102 also includes additional instructions and/or hardware logic blocks such that the processor 104 executes operations in addition to or in place of those discussed above with respect to FIG. 2, in some examples.

As shown in FIG. 2, the processor 104 is configured to execute the instructions 200 to cause an application 134 through which first user information 112 is to be displayed. In some examples, the processor 104 executes application instructions 110 that cause the application 134 to be displayed on one or more computing devices, which may include laptops, smartphones, tablets, and/or the like. The application 134 is a web portal through which the first user information 112 is provided to a first user 130 and a second user 132. In some examples, the application 134 is a school connection application, which provides a web-based application experience to students and guardians of the students. For instance, the application 134 may provide information such as assignments, grades, attendance records, calendar, statuses of assignments, and enrolled courses. That is, instructors of students may upload the information regarding the users to the application 134 and the information pertaining to the students may be provided to the students.

The processor 104, in some examples, causes instructions for the application 134 to be sent over the bus 118, through a network interface 120, and through a network 140 to computing devices of the first user 130 and the second user 132. The network 140 is the Internet in some examples.

In the examples discussed above, the first user 130 is a student and the second user 132 is a guardian of the student. The second user 132 is thus a parent, a grandparent, a sibling, an uncle, an aunt, a family member, a tutor, a custodian, or the like, of the first user 130. In some examples, on an initial use, the first user 130 goes through a registration process with the application 134 in which the first user 130 provides various information including authentication information, e.g., an email address and a password. The email address is used as an identifier of the first user 130 in some examples. The processor 104 may store registration data of the first user 130, for instance, in the data store 108. The first user 130 may provide the information through a student information system.

The processor 104 is configured to execute the instructions 202 to receive authentication information of the second user 132. The authentication information of the second user 132, in some examples, includes an identifier of the second user 132 and information that the second user 132 uses to be authenticated to access an existing web-based application. The existing web-based application is an application that is separate and distinct from the application 134, and may be an email application, a social media application, a financial institution application, or other application that uses a relatively high level of security in authenticating users. The authentication information of the second user 132 is, in some examples, not authentication information that the second user 132 must newly create to become registered to access the first user information 112 via the application 134. Instead, the authentication information of the second user 132 is information that the second user 132 already uses to be authenticated to access another web-based application. In some examples in which the second user 132 does not have existing authentication information or wishes to use new authentication information, the second user 132 may register new authentication information through the application 134. The new authentication information is authentication information that the second user 132 is to use to access the web-based application in addition to the application 134.

The processor 104 is configured to execute the instructions 204 to determine whether the identifier of the second user 132 is linked to an identifier of the first user 130. For instance, when the first user 130 registered with the application 134, the first user 130 may have identified the second user 132, via an identifier of the second user 132, as being linked to the first user 130. The identifier of the first user 130 is, in some examples, an email address of the first user 130, a student identification number of the first user 130, a user name, or a name of the first user 130. Likewise, the identifier of the second user 132 is, in some examples, an email address of the second user 132, an identification number assigned to the second user 132, or a user name of the second user 132. In any of these examples, link information 114, e.g., registration data, that indicates which identifiers of first users are linked to which identifiers of second users are stored in the data store 108. In other examples, the link information 114 is stored in another storage location and the processor 104 accesses the link information 114 from the other storage location. In some examples, the processor 104 determines whether the identifier of the second user 132 is linked to the identifier of the first user 130 based on whether such a link is identified in the link information 114.

In some examples, the processor 104 identifies an email address registered with the first user 130 and determines whether the identified email address matches an email address of the second user 132. The processor 104 also determines that the identifier of the second user 132 is linked to the identifier of the first user 130 based on the identified email address matching the email address of the second user 132.

The processor 104 is configured to execute the instructions 206 to determine whether the authentication information authenticates the second user 132 to access the web-based application. For instance, the authentication information is provided to an identify provider, such as a Microsoft account (MSA) identity provider, which has relatively strong and secure authentication processes. As a result, a relatively stronger and more secure authentication process may be performed on the authentication information than those used to authenticate information used to register with the application 134 itself. As a result, authentication of the second user 132 through use of the authentication information that the second user 132 uses for authentication to access the web-based application is relatively stronger and more secure than authentication information that the second user 132 may have used to become registered to access the application 134 itself. In some examples, the authentication information of the second user 132 incudes authentication information to an account that a web service provider trusts.

The processor 104 is configured to execute the instructions 208 to permit the second user 132 to access the information pertaining to the first user 130 through the application 134 based on a determination that the identifier of the second user 132 is linked to the identifier of the first user 130 and the authentication information authenticates the second user 132 to access the web-based application. Thus, for instance, the second user 132 may access the first user information 112 through the application 134 when the processor 104 determines that the second user 132 is both linked to the first user 130 and has provided valid authentication information to access the web-based application.

The processor 104 is configured to deny the second user 132 access to the information 112 pertaining to the first user 130 through the application 134 based on a determination that the identifier of the second user 132 is not linked to the identifier of the first user 130. Additionally, the processor 104 is configured to deny the second user 132 access to the information pertaining to the first user 130 through the application 134 based on a determination that the authentication information fails to authenticate the second user 132.

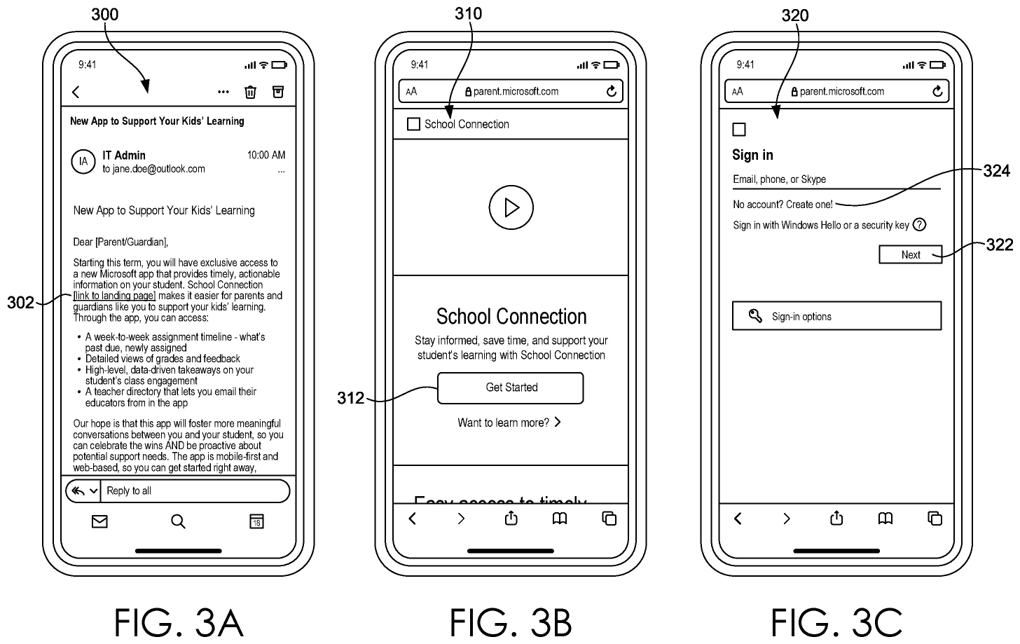

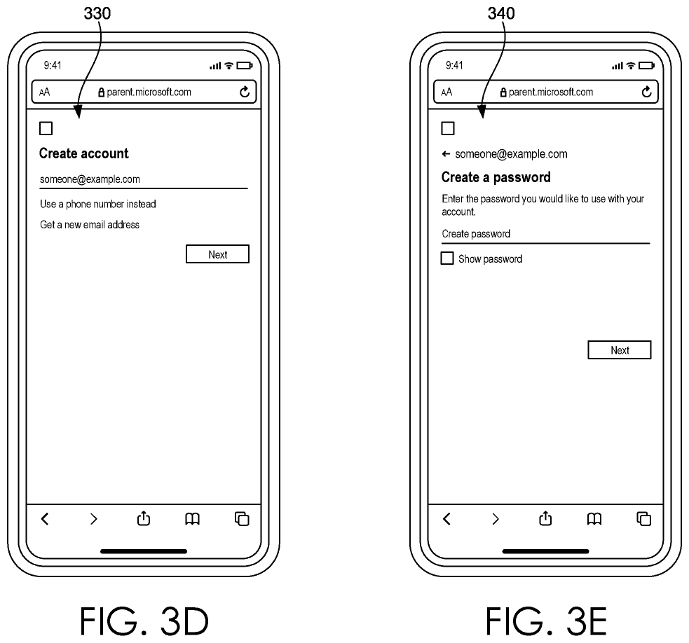

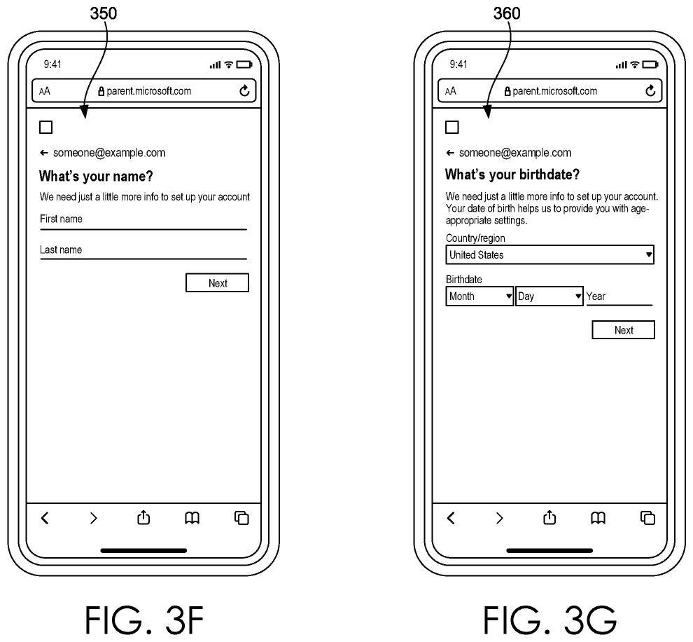

In some examples, the processor 104 causes a message to be sent to the second user 132 to access the application 134. An example of the message 300, in this instance, an email 300, is depicted in FIG. 3A. The email 300 includes a link 302 to a landing page 310 as shown in FIG. 3B. The landing page 310 may be displayed on a computing device of the second user 132 when the link 302 is selected. The landing page 310 is depicted as including a “Get Started” button 312 that the second user 132 is to select. Once selected, a sign in window 320 is displayed as shown in FIG. 3C. The sign in window 320 includes a location at which the second user 132 is to enter their authentication information, such as an email address, a phone number, or other identifier of the second user 132. In instances in which the second user 132 enters their authentication information and presses the “Next” button 322, the second user 132 may be prompted to enter their password. The second user 132 may thus provide authentication information that the second user 132 did not generate to become registered to access the application 134.

However, in instances in which the second user 132 selects the “Create One” option 324, the second user 132 may be prompted to create an account in the window 330 shown in FIG. 3D. That is, based on a determination that the second user 132 has not previously set up the authentication information of the second user 132, the processor 104 causes the application 134 to display instructions for the second user 132 to set up the authentication information of the second user 132. The processor 104 also receives input from the second user 132 to the set up the authentication information of the second user 132. Particularly, the second user 132 inputs an email address of the second user in the window 330 and creates a password in the window 340 as shown in FIG. 3E. The second user 132 provides additional information such as name and birthdate in the windows 340 and 350 respectively depicted in FIGS. 3F and 3G.

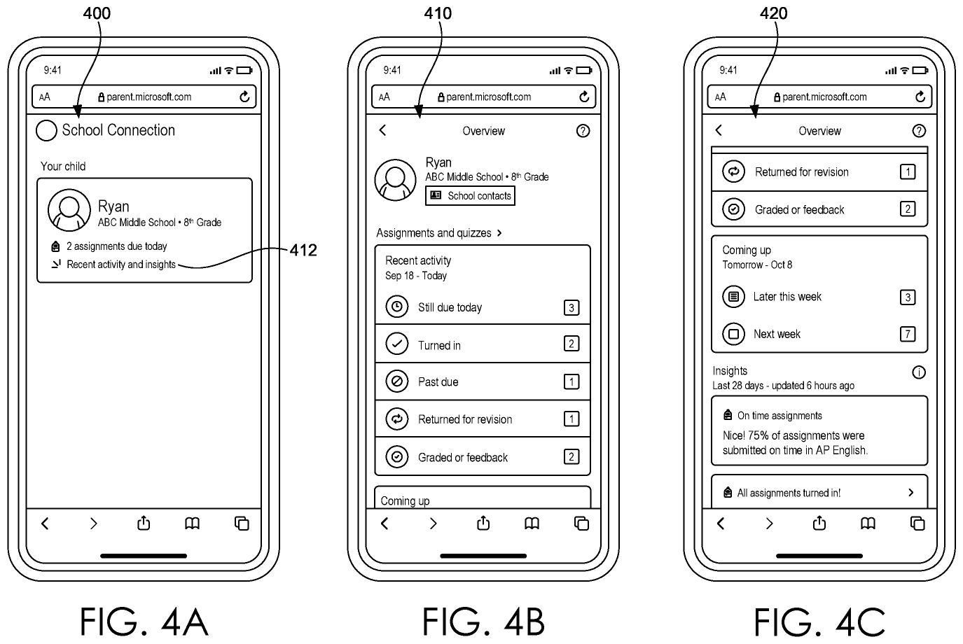

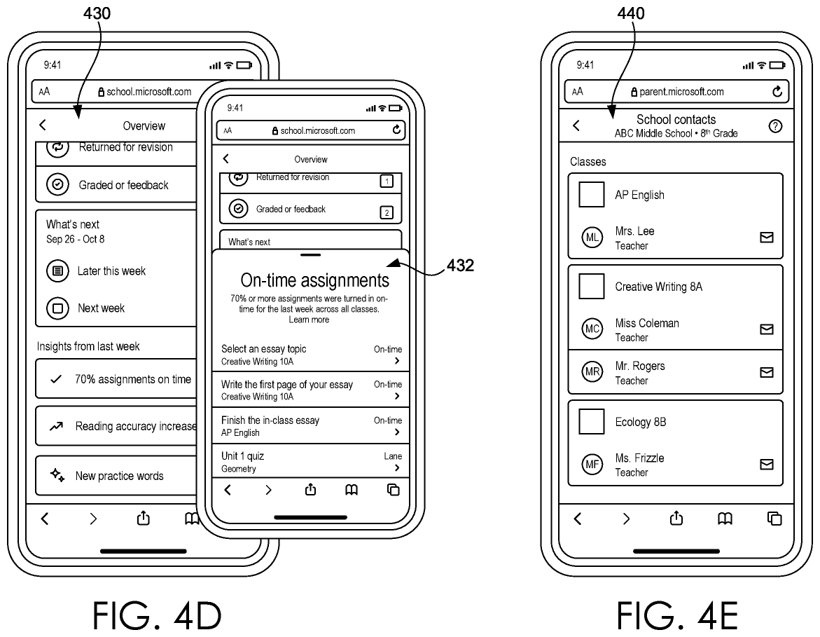

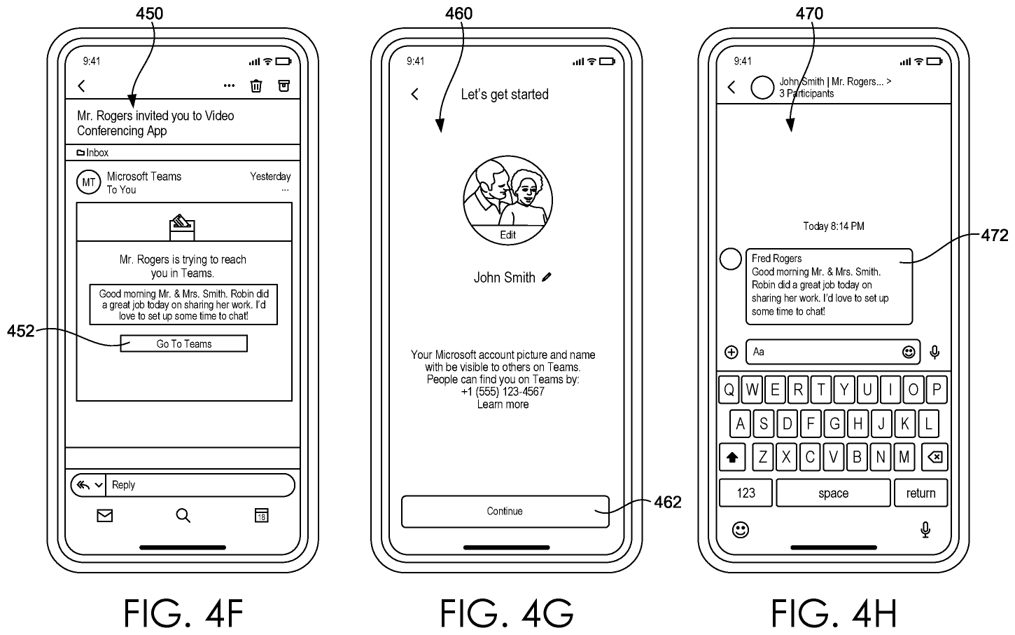

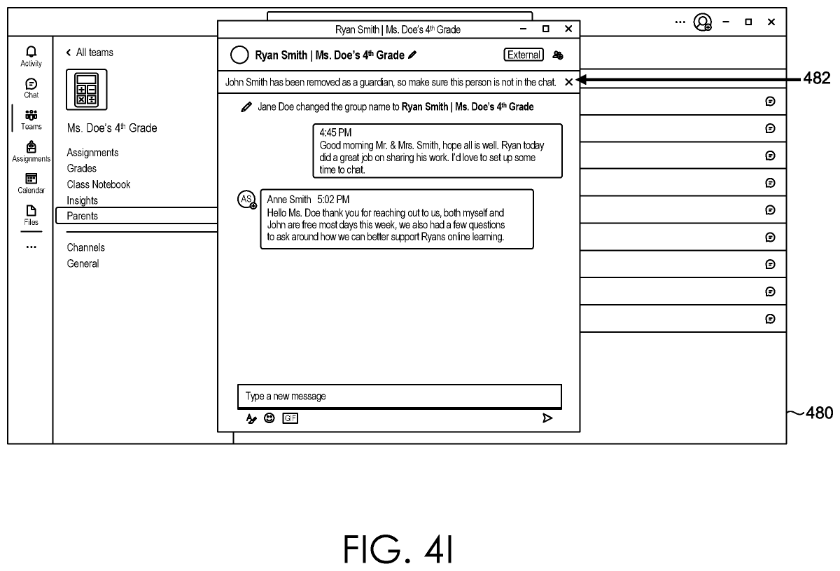

Following authentication of the second user 132, the processor 104 enables the second user 132 to access the first user information 112 through the application 134. An example of a window 400 that includes a link 412 to the first user information 112 is shown in FIG. 4A. Once selected, the first user information 112 may be displayed in windows 410, 420, 430 as respectively shown in FIGS. 4B-4D. Although not shown in the windows 410, 420, 430 the application 134, in some examples, displays other types of information, such as calendars and grades. For instance, the application 134 may show an overlay 432 with first user information (e.g., on-time assignments) or the application 134 may show a window 440 that includes school contacts as shown in FIG. 4E.

In some examples, the application 134 also displays a link for a video conferencing application through which users and educators are able to communicate with each other. An example of a window 450 in which a link 452 for a video conferencing application is displayed is shown in FIG. 4F. Once the link 452 is selected, a window 460 through which the second user 132 may acknowledge that they want to continue with the video conferencing application may be displayed as shown in FIG. 4G. If the “Continue” button 462 is selected, a video conference may be initiated between the second user 132 and an instructor, school administrator, or the like.

In some examples, in addition to or alternatively to the video conference, the second user 132 may communicate with school personnel through a chat application. That is, the school personnel may send chat messages 472 to the second user 132 through the application 134 as shown in the window 470 in FIG. 4H.

Turning now to FIG. 4I, there is shown a window 480 in which a connection between a school official, such as an administrator, teacher, or the like, and the second user 132 may be set up using a school data sync (SDS). In particular, an IT admin may enable a parent connection for a schools video conferencing application using the SDS. The SDS can sync contact information through an automated CSV method and create related contacts. As illustrated in banner 482, if a parent or guardian leaves SDS, the system can display banner 482 to make teachers aware of the change. In some examples, the connection may be made such that the contact information of the school official remains private. That is, the school official may communicate with the second user 132 without sharing their personal email address or phone number.

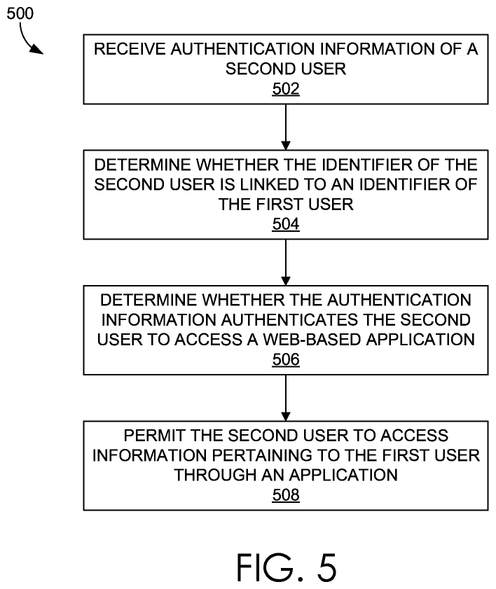

Various manners in which the processor 104 of the apparatus 102 operates are discussed in greater detail with respect to the method 500 depicted in FIG. 5. Particularly, FIG. 5 depicts a flow diagram of a method 500 for providing an application 134 through which a first user 130 and a second user 132 access information pertaining to the first user 130 (e.g., first user information 112) in accordance with an embodiment of the present disclosure. It should be understood that the method 500, in some examples, includes additional operations and that some of the operations described therein are removed and/or modified without departing from the scopes of the method 500. The description of the method 500 is made with reference to the features depicted in FIGS. 1-4C for purposes of illustration.

As shown at block 502, the processor 104 receives authentication information of a second user 132, in which the authentication information includes an identifier of the second user 132 and information that the second user 132 uses for authentication to access a web-based application. As shown at block 504, the processor 104 determines whether the identifier of the second user 132 is linked to an identifier of the first user 130. As shown at block 506, the processor 104 determines whether the authentication information authenticates the second user 132 to access the web-based application. As shown at block 508, based on a determination that the identifier of the second user 132 is linked to the identifier of the first user 130 and the authentication information authenticates the second user 132 to access the web-based application, the processor 104 permits the second user 132 to access information pertaining to the first user 130 through an application 134.

In some examples, some or all of the operations set forth in the method 500 are included as utilities, programs, or subprograms, in any desired computer accessible medium. In addition, the method 500 is embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

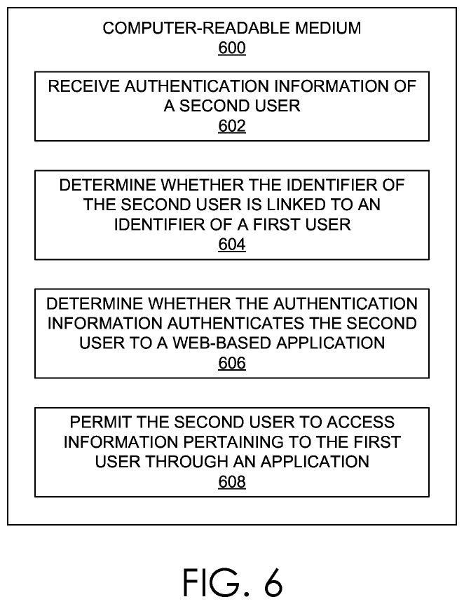

Turning now to FIG. 6, there is shown a block diagram of a computer-readable medium 600 that has stored thereon computer-readable instructions for providing an application 134 through which a first user 130 and a second user 132 are to access information pertaining to the first user 130 (e.g., first user information 112) in accordance with an embodiment of the present disclosure. It should be understood that the computer-readable medium 600 depicted in FIG. 6, in some examples, includes additional instructions and/or some of the instructions described herein are removed and/or modified without departing from the scope of the computer-readable medium 600 disclosed herein. The computer-readable medium 600 is, in some examples, is a non-transitory computer-readable medium, in which the term “non-transitory” does not encompass transitory propagating signals.

The computer-readable medium 600 has stored thereon computer-readable instructions 602-608 that a processor, such as a processor 104 of the apparatus 102 depicted in FIGS. 1 and 2 executes. The computer-readable medium 600 is an electronic, magnetic, optical, or other physical storage device that contains or stores executable instructions. The computer-readable medium 600 is, for example, Random Access memory (RAM), an Electrically Erasable Programmable Read-Only Memory (EEPROM), a storage device, or an optical disc.

The processor fetches, decodes, and executes the instructions 602 to receive authentication information of a second user 132, in which the authentication information includes an identifier of the second user 132 and information that the second user 132 uses for authentication to access a web-based application. The processor fetches, decodes, and executes the instructions 604 to determine whether the identifier of the second user 132 is linked to an identifier of the first user 130. The processor fetches, decodes, and executes the instructions 606 to determine whether the authentication information authenticates the second user 132 to access the web-based application. In addition, the processor fetches, decodes, and executes the instructions 608 to, based on a determination that the identifier of the second user 132 is linked to the identifier of the first user 130 and the authentication information authenticates the second user 132 to access the web-based application, perm it the second user 132 to access information pertaining to the first user 130 through an application 134.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
cause an application to be provided through which information pertaining to a first user is to be displayed, the application is a connection application that supports authenticating a second user to access the information pertaining to the first user that is stored in association with a web-based application;
receive authentication information of the second user, wherein the authentication information includes an identifier of the second user and information that the second user uses for authentication to access the web-based application;
determine whether the identifier of the second user is linked to an identifier of the first user;
determine whether the authentication information authenticates the second user to access the web-based application; and
based on a determination that the identifier of the second user is linked to the identifier of the first user and the authentication information authenticates the second user to access the web-based application, perm it the second user to access the information pertaining to the first user through the application.

2. The apparatus of claim 1, wherein the instructions cause the processor to
access registration data that indicates which identifiers of first users are linked to which identifiers of second users; and
determine whether the identifier of the second user is linked to the identifier of the first user from the accessed registration data.

3. The apparatus of claim 1, wherein the processor controls a resource gateway that authorizes a trust relationship between a consumer cloud and a school cloud for access to information associated with the school cloud.

4. The apparatus of claim 1, wherein the processor controls a resource gateway that supports authenticating the second user with an identity associated with a consumer cloud to access information of the first user with an identity associated with a school cloud.

5. The apparatus of claim 1, wherein the instructions cause the processor to:
deny the second user access to the information pertaining to the first user through the portal based on a determination that the identifier of the second user is not linked to the identifier of the first user; or
deny the second user access to the information pertaining to the first user through the portal based on a determination that the authentication information fails to authenticate the second user.

6. The apparatus of claim 1, wherein the instructions cause the processor to:
cause the portal to display a request as to whether the second user has previously set up the authentication information;
based on a determination that the second user has not previously set up the authentication information, cause the portal to display instructions for the second user to set up the authentication information; and
receive input from the second user to the set up the authentication information.

7. The apparatus of claim 1, wherein the identifier of the second user is associated with an identity provider of a consumer cloud, and the identifier of the first user is associated with an identity provider of a school cloud.

8. The apparatus of claim 1, wherein the instructions cause the processor to:
determine whether the identifier of the second user was previously registered to be linked to the identifier of the first user to determine whether the identifier of the second user is linked to the identifier of the first user; and
determine that the identifier of the second user is linked to the identifier of the first user based on a determination that the identifier of the second user was previously registered to be linked to the identifier of the first user.

9. The apparatus of claim 1, wherein the instructions cause the processor to:
identify an email address registered with the first user;
determine whether the identified email address matches an email address of the second user; and
determine that the identifier of the second user is linked to the identifier of the first user based on the identified email address matching the email address of the second user.

10. The apparatus of claim 1, wherein the first user is a student of an educational institution and the second user is a guardian of the first user.

11. The apparatus of claim 1, wherein the information pertaining to the first user comprises at least one of a calendar, assignments, grades, attendance records, statuses of assignments, and courses.

12. The apparatus of claim 1, wherein the instructions cause the processor to:
provide a link for a video conferencing application in the portal.

13. The apparatus of claim 1, wherein the instructions cause the processor to:
register the second user through the portal.

14. A method comprising:
receiving, by a processor, authentication information of a second user, wherein the authentication information includes an identifier of the second user and information that the second user uses for authentication to access a web-based application;
determining, by the processor, whether the identifier of the second user is linked to an identifier of the first user;
determining, by the processor, whether the authentication information authenticates the second user to access the web-based application; and
based on a determination that the identifier of the second user is linked to the identifier of the first user and the authentication information authenticates the second user to access the web-based application, perm it the second user to access information pertaining to the first user through an application,
wherein the application is a connection application that supports authenticating the second user to access the information pertaining to the first user that is stored in association with the web-based application.

15. The method of claim 14, wherein the processor controls a resource gateway that authorizes a trust relationship between a consumer cloud and a school cloud for access to information associated with the school cloud.

16. The method of claim 14, wherein the processor controls a resource gateway that supports authenticating the second user with an identity associated with a consumer cloud to access the information pertaining to the first user with an identity associated with a school cloud.

17. The method of claim 14, wherein the identifier of the second user is associated with an identity provider of a consumer cloud, and the identifier of the first user is associated with an identity provider of a school cloud.

18. A computer-readable medium on which is stored a plurality of instructions that when executed by a processor, cause the processor to:
receive authentication information of a second user, wherein the authentication information includes an identifier of the second user and information that the second user uses for authentication to access a web-based application;
determine whether the identifier of the second user is linked to an identifier of the first user;
determine whether the authentication information authenticates the second user to access the web-based application; and
based on a determination that the identifier of the second user is linked to the identifier of the first user and the authentication information authenticates the second user to access the web-based application, perm it the second user to access information pertaining to the first user through an application,
wherein the application is a connection application that supports authenticating the second user to access the information pertaining to the first user that is stored in association with the web-based application.

19. The media of claim 18, wherein the processor controls a resource gateway that authorizes a trust relationship between a consumer cloud and a school cloud for access to information associated with the school cloud.

20. The media of claim 18, wherein the processor controls a resource gateway that supports authenticating the second user with an identity associated with a consumer cloud to access the information pertaining to the first user with an identity associated with a school cloud.
